(19) United States
(12) Patent Application Publication
(10) Pub. No.: US 2025/0021327 A1
(43) Pub. Date: Jan. 16, 2025

(54) DELTA PATCHING FOR SHARED LIBRARIES

(71) Applicant: Google LLC, Mountain View, CA (US)

(72) Inventors: Apeksha Singhal, Cupertino, CA (US); Chon Fong Lei, Santa Clara, CA (US); Sopio Chikvinidze, London (GB); Tianran Li, Mountain View, CA (US); Haifeng Ji, Palo Alto, CA (US); Eamon Dominic Hugh, London (GB); Luis Ernesto Silva Vargas, San Jose, CA (US)

(21) Appl. No.: 18/353,009

(22) Filed: Jul. 14, 2023

(51) Int. Cl. G06F 8/658

(52) U.S. Cl. CPC G06F 8/658

(57) ABSTRACT

A computing device may select, out of a plurality of versions of the shared library installed at the computing device, a most recent version of a shared library installed at the computing device that precedes a target version of the shared library as a baseline version of the shared library. The computing device may send, to a computing system, an update request that includes an indication of the baseline version of the shared library. The computing device may, in response to sending the update request, receive, from the computing system, a patch for patching the baseline version of the shared library to the target version of the shared library. The computing device may apply the patch to the baseline version of the shared library to generate the target version of the shared library.

### BACKGROUND

Computing devices such as the mobile phone may execute a wide range of computer programs and software applications, typically called “apps.” Some of the applications may utilize shared libraries in order to perform certain operations or to provide certain features of the application. A computing device may update applications and shared libraries installed at the computing device to new versions of the applications and shared libraries to fix bugs and other issues and/or to introduce new features.

### SUMMARY

Techniques are described by which a computing system and computing device may operate to enable the computing device to update a shared library installed at the computing device to a target version by patching the shared library instead of downloading the entire target version of the shared library. Certain shared libraries are not compatible between different versions of the same shared library. That is, applications may depend on a specific version of the shared library in order to function. As such, if different applications installed at the computing device depend on different versions of the same shared library, the computing device may install multiple different versions of the shared library for use by the different applications.

The computing device may update an application that depends on a specific version of a shared library, such as by downloading an updated version of the application from a computing system that is part of an application distribution service and by installing the updated version of the application. However, if the updated application depends on a newer version of the shared library, the updated application may no longer be able to use the specific version of the shared library used by the same application prior to the update. As such, the computing device may have to download the newer version of the shared library on which the updated application depends in order for the updated application to function, which may require the computing device to download a large amount of data (e.g., hundreds of megabyte of data or more).

In accordance with aspects of this disclosure, the computing device may perform delta patching of an older version of a shared library to generate a newer version of the shared library. As the computing device may include multiple different versions of that shared library, the computing device may select a version of the shared library installed at computing device to act as a baseline version of the shared library that is to be patched to generate the newer version of the shared library on which the updated application depends, where the newer version of the shared library is referred herein as the targeted version of the shared library.

The computing device may therefore select the most recent version of the shared library out of all of the versions of that shared library installed at the computing device that precedes the target version of the shared library as the baseline version of the shared library that is to be patched to generate the target version of the shared library. The computing device may send an update request to the computing system that indicates the baseline version of the shared library that is to be patched and may, in response, receive a patch for patching the baseline version of the shared library to generate the target version of the shared library. The computing device may therefore apply the patch to the baseline version of the shared library to generate the target version of the shared library.

In some aspects, the techniques described herein relate to a method including: selecting, by one or more processors of a computing device and out of a plurality of versions of a shared library installed at the computing device, a most recent version of the shared library that precedes a target version of the shared library as a baseline version of the shared library; sending, by the one or more processors to a computing system, an update request that includes an indication of the baseline version of the shared library; in response to sending the update request, receiving, by the one or more processors and from the computing system, a patch for patching the baseline version of the shared library to the target version of the shared library; and applying, by the one or more processors, the patch to the baseline version of the shared library to generate the target version of the shared library.

In some aspects, the techniques described herein relate to a computing device including: a memory configured to store a plurality of versions of a shared library installed at the computing device; one or more processors operably coupled to the memory and configured to: select, out of the plurality of versions of a shared library installed at the computing device, a most recent version of the shared library that precedes a target version of the shared library as a baseline version of the shared library; send, to a computing system, an update request that includes an indication of the baseline version of the shared library; in response to sending the update request, receive, from the computing system, a patch for patching the baseline version of the shared library to the target version of the shared library; and apply the patch to the baseline version of the shared library to generate the target version of the shared library.

In some aspects, the techniques described herein relate to a computer-readable storage medium encoded with instructions that, when executed by one or more processors of a computing device, cause the one or more processors to: select, out of a plurality of versions of a shared library installed at the computing device, a most recent version of the shared library that precedes a target version of the shared library as a baseline version of the shared library; send, to a computing system, an update request that includes an indication of the baseline version of the shared library; in response to sending the update request, receive, from the computing system, a patch for patching the baseline version of the shared library to the target version of the shared library; and apply the patch to the baseline version of the shared library to generate the target version of the shared library.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing system and computing device for updating shared libraries in accordance with techniques of this disclosure.

FIG. 2 is a block diagram illustrating an example computing device for managing application updates in accordance with techniques of this disclosure.

FIGS. 3A and 3B are conceptual diagrams illustrating example techniques for updating shared libraries, in accordance with techniques of this disclosure.

FIG. 4 is a flowchart illustrating another exemplary operation of the computing system and computing device in accordance with techniques of this disclosure.

### DETAILED DESCRIPTION

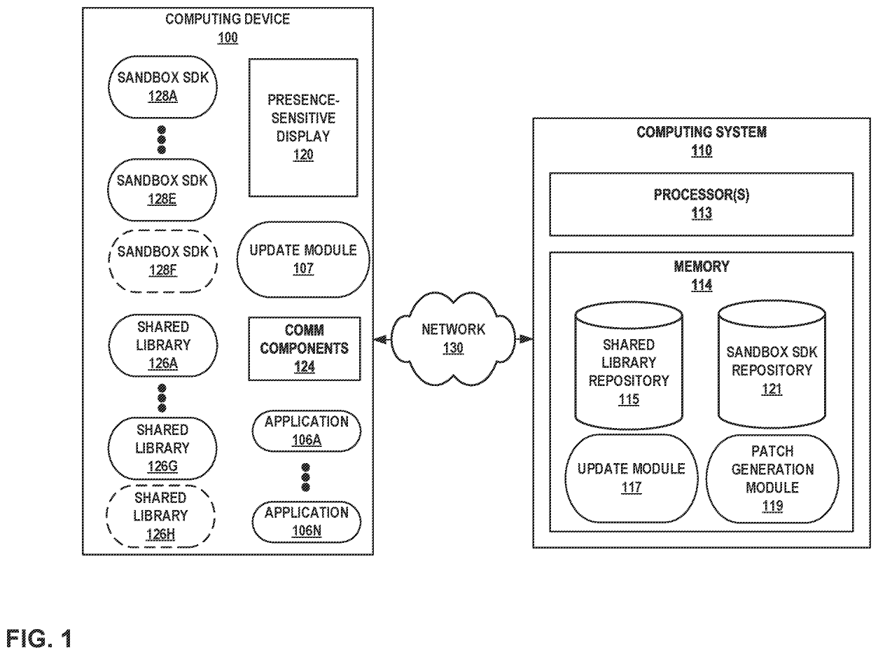

FIG. 1 is a conceptual diagram illustrating an example computing system and computing device for updating shared libraries, in accordance with techniques of this disclosure. As shown in the example of FIG. 1, a computing device 100 may communicate with a computing system 110 over network 130 to update shared libraries, in accordance with one or more techniques of this disclosure.

In the example of FIG. 1, computing device 100 is a mobile computing device. However, computing device 100 may be any mobile or non-mobile computing device, such as a cellular phone, a smartphone, a desktop computer, a laptop computer, a tablet computer, a portable gaming device, a portable media player, an e-book reader, a watch (including a so-called smartwatch), an add-on device (such as a casting device), smart glasses, a gaming controller, a vehicle computer, or another type of computing device.

Similarly, computing system 110 may be any suitable remote computing system, such as one or more desktop computers, laptop computers, mainframes, servers, cloud computing systems, virtual machines, etc. capable of sending and receiving information via network 130. In some examples, computing system 110 may represent a cloud computing system that provides one or more services via network 130. That is, in some examples, computing system 110 may be a distributed computing system in which one or more computing devices coordinate execution of threads to collaboratively perform one or more operations attributed to computing system 110. One or more computing devices, such as computing device 100, may access the services provided by the cloud by communicating with computing system 110. While described herein as being performed at least in part by computing system 110, any or all techniques of the present disclosure may be performed by one or more other devices, such as computing device 100. That is, in some examples, computing device 100 may be operable to perform one or more techniques of the present disclosure alone.

Computing system 110 includes one or more processors 113 and memory 114. Processors 113 may implement functionality and/or execute instructions associated with computing system 110. Examples of processors 113 include application processors, display controllers, auxiliary processors, one or more sensor hubs, and any other hardware configured to function as a processor, a processing unit, or a processing device (including field programmable gate arrays—FPGAs, application specific integrated circuits—ASICS, general purpose processors, graphics processing units—GPU, etc.). Update module 117, patch generator module 119, and the like may be operable (or, in other words, executed) by processors 113 to perform various actions, operations, or functions of computing system 110. That is, update module 117 and patch generator module 119 may each form executable bytecode, which when executed, cause processors 113 to perform specific operations in accordance with (e.g., causing computing system 110 to become a specific-purpose computer by which to perform) various aspects of the techniques described herein.

Computing system 110 may further include memory 114. Memory 114 may store shared library repository 115, update module 117, patch generator module 119, and sandbox software development kit (SDK) repository 121. Memory 114 may, in some examples, be described as a computer-readable storage medium. In some examples, memory 114 is a temporary memory, meaning that a primary purpose of memory 114 is not long-term storage. Memory 114 may also be described as a volatile memory, meaning that memory 114 does not maintain stored contents when computing system 110 is turned off (or, in other words, powered off). Examples of volatile memories include random access memories (RAM), dynamic random-access memories (DRAM), static random-access memories (SRAM), and other forms of volatile memories known in the art. In some examples, memory 114 may be used to store program instructions for execution by processors 113. Memory 114 may be used by software or applications running on computing system 110 (e.g., software required to generate patches for shared libraries) to temporarily store information during program execution.

Computing device 100 may include applications 106A-106N (collectively “applications 106), shared libraries 126A-126G (collectively “shared libraries 126”), sandbox software development kits (SDKs) 128A-128E (collectively “sandbox SDKs 128”), update module 107, presence-sensitive display 120, and communication (“COMM”) components 124. Display 120 may be a presence-sensitive display that functions as an input device and as an output device. For example, the presence-sensitive display may function as an input device using a presence-sensitive input component, such as a resistive touchscreen, a surface acoustic wave touchscreen, a capacitive touchscreen, a projective capacitance touchscreen, a pressure sensitive screen, an acoustic pulse recognition touchscreen, or another presence-sensitive display technology. The presence-sensitive display may function as an output (e.g., display) device using any of one or more display components, such as a liquid crystal display (LCD), dot matrix display, light emitting diode (LED) display, microLED display, organic light-emitting diode (OLED) display, e-ink, active matrix organic light-emitting diode (AMOLED) display, or similar monochrome or color display capable of outputting visible information to a user of computing device 100.

COMM components 124 may receive and transmit various types of information, such as information concerning pending updates associated with one or more applications 106 installed on computing device 100, over network 130. Network 130 may include a wide-area network such as the Internet, a local-area network (LAN), a personal area network (PAN) (e.g., Bluetooth®), an enterprise network, a wireless network, a cellular network, a telephony network, a Metropolitan area network (e.g., WIFI, WAN, WiMAX, etc.), one or more other types of networks, or a combination of two or more different types of networks (e.g., a combination of a cellular network and the Internet).

COMM components 124 may include wireless communication devices capable of transmitting and/or receiving communication signals using network 130, such as a cellular radio, a 3G radio, a 4G radio, a 5G radio, a Bluetooth® radio (or any other PAN radio), an NFC radio, or a WIFI radio (or any other WLAN radio). Additionally or alternatively, COMM components 124 may include wired communication devices capable of transmitting and/or receiving communication signals via a direct link over a wired communication medium (e.g., a universal serial bus (“USB”) cable).

Computing device 100 may execute one or more applications 106. Applications 106 may represent first party applications or components developed and provided as an application integrated into an operating system or third-party applications that a user of computing device 100 obtains via application store services provided by way of the operating system, computing system 110, or another computing system. Application 106 may, as a few examples, provide gaming services (e.g., video games), email services, web browsing services, texting and/or chat services, web conferencing services, video conferencing services, music services (including streaming music services), video services (including video streaming services), navigation services, word processing services, spreadsheet services, slide and/or presentation services, assistant services, text entry services, or any other service commonly provided by applications.

Computing device 100 includes shared libraries 126. A shared library, such as shared library 126A, may be one or more files containing compiled code, such as functions, and data that can be referenced and used by multiple applications (e.g., two or more of applications 106) to perform certain operations or provide certain features. For example, shared library 126A may provide a web browsing component and two or more of applications 106 may link to shared library 126A to provide web browsing functionality to access and render web pages.

Each shared library of shared libraries 126 may be a static shared library. A static shared library may be a shared library that simulates static linking while allowing for multiple applications to reuse the same instance of the library. That is, a static shared library may enable an application to link to a specific version of the shared library without having to bundle the library within the application. At runtime of an application that links to a specific version of the static shared library, computing device 100 may copy the code and data of the specific version of the static shared library into the application's process space, thereby effectively making the specific version of the static shared library a part of the application. The application may therefore be able to directly access the symbols of the specific version of the static shared library, which may improve the performance of the application by reducing the number of times computing device 100 may have to load code and data of the specific version of the static shared library from memory.

A static shared library may not be compatible between different versions of the same shared library. As such, an application that links to and/or depends on specific versions of a shared library may not be able to access functionalities of a different version of the same shared library without recompiling the application to link to a different version of the same shared library.

For example, a newer version of a shared library may deprecate one or more functions in an older version of the same shared library and may have replaced the one ore more deprecated functions with one or more new functions. As such, an application that links to the older version of the shared library and calls those one or more functions in the older version of the shared library may not be able to link to the newer version of the shared library because the newer version of the shared library may no longer support calling of those one or more functions.

In the example of FIG. 1, computing device 100 includes shared libraries 126, which include different versions of the same static shared library (e.g., different versions of a web browsing component), and two or more of applications 106 may link to and depend upon different versions of the same shared library to perform certain operations or to provide certain features. For example, application 106A may link to shared library 126A and application 106N may link to shared library 126G, which are different versions of the same shared library. In examples where shared library 126A and shared library 126G are static shared libraries, application 106A that links to shared library 126A may not be able to link to shared library 126G even though shared library 126A and shared library 126G are different versions of the same shared library.

Computing device 100 includes sandbox SDKs 128. Sandbox SDKs 128 are SDKs that execute in dedicated runtime environments, that are isolated processes associated with applications 106, also referred to as sandbox environments, to provide various functionalities to applications 106. Sandbox SDKs may execute in runtime environments that are separated (e.g., sandboxed) from the runtime environments of the applications that use the sandbox SDKs, thereby enhancing the privacy of the users of the applications by preventing data collection and data sharing without user consent. For example, an instance of a sandbox SDK, such as sandbox SDK 128A, may execute in a sandbox environment associated with application 106A in order to provide one or more functionalities that application 106A may use. For example, an application may use a sandbox SDK associated with a social media company to integrate features provided by the social media company, such as single sign on, a social graph, advertising, and the like into the application. In another example, an application may use a sandbox SDK that performs analytics reporting to integrate application analytics features, such as crash reporting, into the application.

Similar to static shared libraries, a sandbox SDK may not be compatible between different versions of the same sandbox SDK. As such, an application that uses a specific version of a sandbox SDK may not be able to access functionalities of a different version of the same sandbox SDK. In the example of FIG. 1, computing device 100 includes sandbox SDKs 128, which include different versions of the same sandbox SDK (e.g., different versions of a sandbox SDK that provides analytics reporting), and two or more of applications 106 may link to and depend upon different versions of the same sandbox SDK to perform certain operations or to provide certain features. For example, application 106A may use sandbox SDK 128A and application 106N may use sandbox SDK 128E, which may be different versions of the same sandbox SDK that performs analytics reporting. Because sandbox SDKs are not compatible between different versions of the same sandbox SDK, application 106A that uses shared library 126A may not be able to use shared library 126G even though sandbox SDK 128A and sandbox SDK 128E are different versions of the same shared library.

In some examples, if different applications use the same version of the same sandbox SDK, computing device 100 may include multiple instances of the same version of the same sandbox SDK because each instance of a sandbox SDK used by an application runs in a separate sandbox environment associated with the application. As such, if application 106A and application 106N both use the same version of the same sandbox SDK, computing device 100 may include sandbox SDK 128A and sandbox SDK 128E that are different instances of the same version of the same sandbox SDK, so that sandbox SDK 128A may execute in a sandbox environment associated with application 106A and sandbox SDK 128E may execute in a sandbox environment associated with application 106N.

Computing device 100 may execute update module 107 to facilitate management of application updates, shared library updates, and/or sandbox SDK updates by operating in conjunction with an update module 117 of computing system 110. For example, computing device 100 may use update module 107 to update applications 106 shared libraries 126, and/or sandbox SDKs 128 installed at computing device 100 to new versions of such applications 106 and shared libraries published by developers to computing system 110 (e.g., to an online application store provided by computing system 110). In various instances, update module 107 may be a client application associated with an online application store managed and/or provided by computing system 110.

From time-to-time developers of various applications may add new features, fix various bugs, fix various security issues, or otherwise update the software code for an application and/or a shared library. The developer may publish a new version of the application (e.g., for application 106A) to the online application store provided by computing system 110, and computing device 100 may use update module 107 to download and install new versions of applications installed at computing device 100. For example, computing device 100 may use one or more COMM components 124 to receive, from computing system 110, data for updating an application installed at computing device 100 to a newer version of the application published at computing system 110, and computing device may use update module 107 to apply the patch to the application to update the application. For example, if the developer of application 106A publishes a newer version of application 106A to computing system 110, computing device 100 may be able to update application 106A to the published new version by downloading a patch from computing system 110 to update application 106A to the published new version and by applying the patch to application 106A installed at computing device 100 to install the new version of application 106A at computing device 100.

In some examples, a new version of an application may depend on a different version of a shared library (e.g., a newer version of the shared library) than a previous version of the same application. For example, while the version of application 106A installed at computing device 100 may depend on a particular version of a shared library, represented by shared library 126A, a new version of application 106A may depend on a newer, different version of the same shared library, and may not be able to use shared library 126A used by the previous version of application 106A. Such a newer, different version of a shared library is referred to herein as a target version of the shared library.

Computing device 100 may receive, from computing system 110, an indication of the target version of a shared library on which a new version of the application depends. Computing device 100 may, in response to receiving the indication of the target version of the shared library, determine whether the target version of the shared library is installed at computing device 100. If computing device 100 determines that the target version of the shared library is not already installed at computing device 100, computing device 100 may install the target version of the shared library.

In some examples, computing device 100 may install the target version of the shared library used by the application to by downloading and installing the target version of the shared library from computing system 110. However, the size of a shared library may be relatively large (e.g., over one hundred of megabyte). As such, downloading the target version of the shared library may cause computing device 100 to download a relatively large amount of data. Causing the computing device 100 to download a relatively large amount of data when updating a shared library may increase the time it may take for computing device 100 to install the target version of the shared library, which may decrease the user experience of computing device 100 by increasing the wait time for the user of computing device 100 to be able to use an updated application that depends on the target version of the shared library.

Further, causing the computing device 100 to download a relatively large amount of data when updating a shared library may negatively impact the performance of computing device 100. For example, downloading a relatively large amount of data may require sustained network activity, which may drain computing device 100's battery in examples where computing device 100 is a mobile computing device (e.g., a smartphone). Downloading a relatively large amount of data may also increase the processing load of computing device 100. Increasing the processing load of computing device 100 may cause the processing performance of computing device 100 to decrease, especially the performance of tasks other than downloading data. Increasing the processing load of computing device 100 may also cause increased heat generation by processing components and/or networking components of computing device 100, thereby potentially leading to overheating of computing device 100.

In addition, causing the computing device 100 to download a relatively large amount of data when updating a shared library may increase the data usage of computing device 100. If computing device 100 is using a data plan provided by a service provider that imposes a limit on the amount of data transferred by a user account over a given period of time, the relatively large amount of data downloaded by computing device 100 when updating a shared library may cause computing device 100 to more quickly consume the data allotted to the user of computing device 100 by the data plan, which may lead to the service provider potentially throttling computing device 100 and/or imposing data overage charges.

In accordance with aspects of this disclosure, computing device 100 may reduce the amount of data that computing device 100 has to download to install a target version of the shared library by downloading a patch that computing device 100 may use to update a version of the shared library installed at computing device to the target version of the shared library. Because a target version of the shared library may share a significant amount of code with an older version of the same shared library installed at computing device 100, a patch for updating the older version of the shared library to the target version of the same shared library may not have to include all of the code of the target version of the shared library. Instead, the patch may include a subset of the code of the target version of the shared library to update the older version of the shared library to the target version of the same shared library, thereby reducing the amount of data that computing device 100 has to download to install the target version of the shared library at computing device 100.

Computing device 100 may select, out of the versions of a shared library installed at computing device 100, a baseline version of the shared library that is to be patched to generate the target version of shared library. That is, because different versions of a shared library may currently be installed at computing device 100, computing device 100 may select one version of the shared library out of the versions of the same shared library installed at computing device 100 as the baseline version of the shared library that is to be patched to generate the target version of the shared library. For example if shared library 126A and shared library 126G are different versions of the same shared library, such that shared library 126A and shared library 126G have different version numbers, computing device 100 may select one of shared library 126A and shared library 126G as the baseline version of the shared library to be patched to generate the target version of the shared library.

Computing device 100 may select, out of the versions of a shared library installed at computing device 100, a most recent version of the shared library that precedes the target version of the shared library as the baseline version of the shared library that is to be patched to generate the target version of the shared library. The most recent version of a shared library that precedes the target version of the same shared library out of the versions of that shared library installed at computing device 100 may be the version of the shared library having the highest version (e.g., having the highest version number) out of the versions of the shared library installed at computing device 100 that is of a lower version (e.g., a lower version number) than the version number of the target version of the shared library. In another example, the most recent version of the shared library that precedes the target version of the shared library out of the versions of the shared library installed at computing device 100 may be the most recently released version of the shared library out of the versions of the shared library installed at computing device 100 that was released prior to the release of the target version of the shared library.

The most recent version of the shared library that precedes the target version of the shared library out of the versions of the shared library installed at computing device 100 may share the most amount of code with the target version of the shared library out of the versions of the shared library installed at computing device 100. As such, selecting the most recent version of the shared library that precedes the target version of the shared library out of the versions of the shared library installed at computing device 100 as the baseline version of the shared library may reduce the size of the patch used to generate the target version of the shared library.

For example, the target version of a shared library may be version 11 of the shared library, the version of shared library 126A may be version 10 of the shared library, and the version of shared library 126G may be version 8 of the shared library. Because the version of shared library 126A is a higher version of the shared library than the version of shared library 126G and because the version of shared library 126A is a lower version than the target version of the shared library, computing device 100 may determine shared library 126A to be the baseline version of the shared library.

Computing device 100 may use one or more COMM components 124 to send, to computing system 110, a request to update a shared library to a target version of the shared library. The request may indicate the shared library to be updated, such as by including an indication of the name of the shared library. The request may also indicates the baseline version of the shared library to be patched, such as by including an indication of the version number of the baseline version of the shared library. In the example where shared library 126A is selected as the baseline version of the shared library, the request may indicate the name of shared library 126A and the version number of shared library 126A.

Computing system 110 may receive the request to update a shared library and may, in response, generate a patch for patching the baseline version of the shared library indicated by the request to generate the target version of the shared library. To generate the patch, patch generator module 119 may retrieve the baseline version of the shared library and the target version of the shared library from shared library repository 115, and may compare the baseline version of the shared library with the target version of the shared library to identify differences between the baseline version of the shared library with the target version of the shared library, such as by comparing the source code, binary files, or other relevant data associated with the baseline version of the shared library and the target version of the shared library. For example, patch generator module 119 may retrieve, from shared library repository 115, the source code, binary files, or other relevant data associated with the baseline version of the shared library indicated by the request as well as the source code, binary files, or other relevant data associated with the target version of the shared library to identify differences between the baseline version of the shared library and the target version of the shared library.

Patch generator module 119 may, based on the differences between the baseline version of the shared library with the target version of the shared library, create a patch that contains instructions (e.g., code) and/or data to transform the baseline version of the shared library into the target version of the shared library. Such a patch is referred to as a delta patch because the patch does not contain all of the code and data of the target version of the shared library, but may instead include code and data that have changed between the baseline version of the shared library and the target version of the shared library. Computing system 110 may therefore send, to computing device 100, the patch for patching the baseline version of the shared library indicated in the request to the target version of the shared library.

Computing device 100 may receive the patch for patching the baseline version of the shared library indicated in the request to the target version of the shared library. Computing device 100 may, in response to receiving the patch, apply the patch to the baseline version of the shared library to generate and install the target version of the shared library, such as by executing the code contained within the patch to update the baseline version of the shared library to generate the target version of the shared library at computing device 100. For example, if computing device 100 determines that shared library 126A is the baseline version of a shared library to be patched to generate the target version of the shared library, computing device 100 may apply the patch to shared library 126A to create shared library 126H, which is the target version of the shared library, at computing device 100.

Similar to the techniques for updating shared libraries, computing device 100 may be able to update a version of a sandbox SDK used by an application to a new version of the sandbox SDK. For example, application 106A may use a particular sandbox SDK, such as sandbox SDK 128A, that executes in a sandboxed environment, and update module 107 may update an application, such as application 106A, to a newer version of the application that uses a newer version of the particular sandbox SDK, referred to herein as a target version of the sandbox SDK.

Computing device 100 may receive, from computing system 110, an indication of the target version of the sandbox SDK on which a new version of the application depends. Computing device 100 may, in response to receiving the indication of the target version of the sandbox SDK, determine whether the target version of the sandbox SDK is installed at computing device 100. If computing device 100 determines that the target version of the sandbox SDK is not already installed at computing device 100, computing device 100 may install the target version of the sandbox SDK.

Computing device 100 may select, out of the versions of a sandbox SDK installed at computing device 100, a baseline version of the sandbox SDK that is to be patched to generate the target version of the sandbox SDK. For example if sandbox SDK 128A and sandbox SDK 128E are different versions of the same sandbox SDK, computing device 100 may select one of sandbox SDK 128A and sandbox SDK 128E as the baseline version of the sandbox SDK to be patched to generate the target version of the sandbox SDK.

Computing device 100 may select, out of the versions of a sandbox SDK installed at computing device 100, a most recent version of the sandbox SDK that precedes the target version of the sandbox SDK as the baseline version of the sandbox SDK he sandbox SDK that is to be patched to generate the target version of the shared library. The most recent version of a sandbox SDK that precedes the target version of the same sandbox SDK out of the versions of that sandbox SDK installed at computing device 100 may be the version of the sandbox SDK having the highest version number out of the versions of the sandbox SDK installed at computing device 100 that is of a lower version than the version number of the target version of the sandbox SDK. In another example, the most recent version of the sandbox SDK that precedes the target version of the sandbox SDK out of the versions of the sandbox SDK installed at computing device 100 may be the most recently released version of the sandbox SDK out of the versions of the sandbox SDK installed at computing device 100 that was released prior to the release of the target version of the sandbox SDK.

Computing device 100 may use one or more COMM components 124 to send, to computing system 110, a request to update a sandbox SDK to a target version of the sandbox SDK. The request may indicate the sandbox SDK to be updated, such as by including an indication of the name of the sandbox SDK. The request may also indicates the baseline version of the sandbox SDK to be patched, such as by including an indication of the version number of the baseline version of the sandbox SDK. In the example where sandbox SDK 128E is selected as the baseline version of the shared library, the request may indicate the name of sandbox SDK 128E and the version number of sandbox SDK 128E.

Computing system 110 may receive the request to update a sandbox SDK and may, in response, generate a patch for patching the baseline version of the sandbox SDK indicated by the request to generate the target version of the sandbox SDK. To generate the patch, patch generator module 119 may compare the baseline version of the sandbox SDK with the target version of the sandbox SDK to identify differences between the baseline version of the sandbox SDK with the target version of the sandbox SDK, such as by comparing the source code, binary files, or other relevant data associated with the baseline version of the sandbox SDK and the target version of the sandbox SDK. For example, patch generator module 119 may retrieve, from sandbox SDK repository 121, the source code, binary files, or other relevant data associated with the baseline version of the sandbox SDK indicated by the request as well as the source code, binary files, or other relevant data associated with the target version of the sandbox SDK to identify differences between the baseline version of the sandbox SDK and the target version of the sandbox SDK.

Patch generator module 119 may, based on the differences between the baseline version of the sandbox SDK with the target version of the sandbox SDK, create a patch that contains instructions (e.g., code) and/or data to transform the baseline version of the sandbox SDK into the target version of the sandbox SDK. Such a patch is referred to as a delta patch because the patch does not contain all of the code and data of the target version of the sandbox SDK, but may instead include code and data that have changed between the baseline version of the sandbox SDK and the target version of the sandbox SDK. Computing system 110 may therefore send, to computing device 100, the patch for patching the baseline version of the sandbox SDK indicated in the request to the target version of the sandbox SDK.

Computing device 100 may receive the patch for patching the baseline version of the sandbox SDK indicated in the request to the target version of the sandbox SDK. Computing device 100 may, in response to receiving the patch, apply the patch to the baseline version of the sandbox SDK to generate and install the target version of the sandbox SDK, such as by executing the code contained within the patch to update the baseline version of the sandbox SDK to generate the target version of the sandbox SDK at computing device 100. For example, if computing device 100 determines that sandbox SDK 128E is the baseline version of a sandbox SDK to be patched to generate the target version of the sandbox SDK, computing device 100 may apply the patch to sandbox SDK 128E to create sandbox SDK 128F, which is the target version of the sandbox SDK.

Various aspects of the techniques may decrease the amount of data that is transferred by computing device 100 in order to update shared libraries and sandbox SDKs, thereby improving the performance of computing device 100. By decreasing the amount of data that is transferred by computing device 100 in order to update shared libraries and sandbox SDKs, the techniques of this disclosure may decrease the time it may take for computing device 100 to install new versions of shared libraries and sandbox SDKs, which may decrease the wait time for the user of computing device 100 to be able to use an updated application that depends on new versions of shared libraries and/or sandbox SDKs.

Further, decreasing the amount of data that is transferred by computing device 100 in order to update shared libraries and sandbox SDKs may decrease the amount of network activity sustained by computing device 100 and may decrease the amount of time during which computing device may operate under an increased processing load to transfer data, thereby reducing battery drain of computing device 100 and reducing the amount of heat generated by processing components and/or networking components of computing device 100 during data transfer.

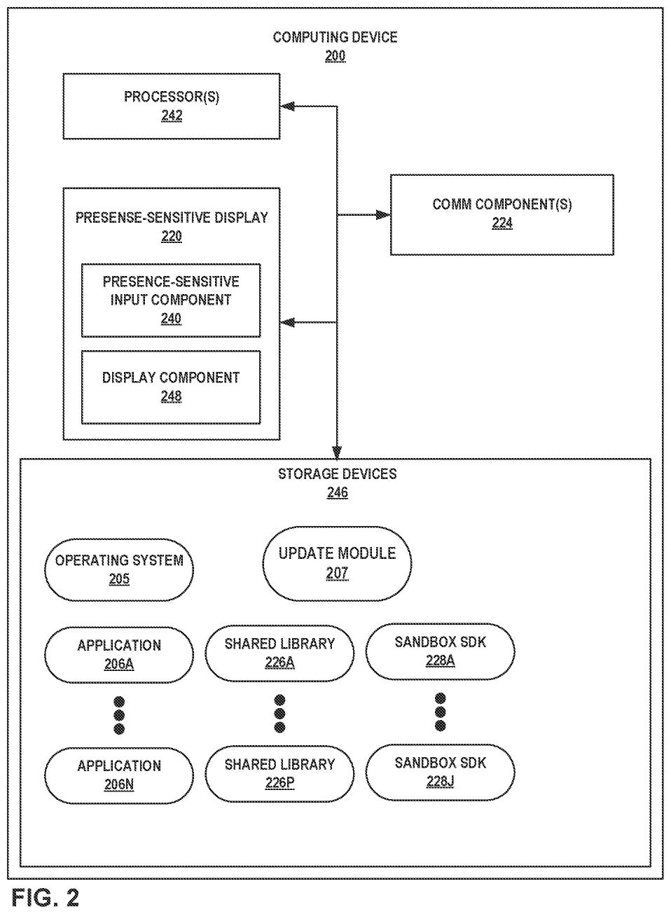

FIG. 2 is a block diagram illustrating an example computing device for updating shared libraries in accordance with techniques of this disclosure. Computing device 200 shown in the example of FIG. 2 is one example of computing device 100 shown in FIG. 1.

As shown in the example of FIG. 2, computing device 200 includes presence-sensitive display 220, which may be similar if not substantially similar to presence-sensitive display 120, one or more processors 242, one or more COMM components 224, which may be similar if not substantially similar to COMM components 124, and one or more storage devices 246. One or more storage devices 246 of computing device 200 may include an operating system 205, one or more applications 206A-206N (collectively, “applications 206”), update module 207, shared libraries 226A-226P (collectively, “shared libraries 226”), and sandbox SDKs 228A-228J (collectively, sandbox SDKs 228″). Applications 206 are examples of applications 106 of FIG. 1, update module 207 is an example of update module 107 of FIG. 1, shared libraries 226 are examples of shared libraries 126 of FIG. 1, and sandbox SDKs 228 are examples of sandbox SDKs 128 of FIG. 1.

Presence-sensitive display 220 of computing device 200 may include functionality of an input component and/or an output component. In the example of FIG. 2, presence-sensitive display 220 may include a presence-sensitive input (PSI) component 240 (“PSI component 240”), such as a presence-sensitive screen or touch-sensitive screen. In some examples, presence-sensitive input component 240 may detect an object at and/or near the presence-sensitive input component. As one example range, presence-sensitive input component 240 may detect an object, such as a finger or stylus that is within two inches or less of presence-sensitive input component 240. Presence-sensitive input component 240 may determine a location (e.g., an (x, y) coordinate) of the presence-sensitive input component at which the object was detected. In another example range, presence-sensitive input component 240 may detect an object two inches or less from presence-sensitive input component 240 and other ranges are also possible. Presence-sensitive input component 240 may determine the location of presence-sensitive input component 240 selected by a user's finger using capacitive, inductive, and/or optical recognition techniques.

In some examples, presence-sensitive display 220 may also provide output to a user using tactile, audio, or video stimuli. For example, presence-sensitive display 220 may include display component 248 that displays a graphical user interface. Display component 248 may be any type of output component that provides visual output such as a liquid crystal display (LCD), dot matrix display, light emitting diode (LED) display, microLED display, organic light-emitting diode (OLED) display, e-ink, active-matrix organic light-emitting diode (AMOLED) display, etc. While illustrated as an integrated component of computing device 200, presence-sensitive display 220 may, in some examples, be an external component that shares a data or information path with other components of computing device 200 for transmitting and/or receiving input and output data.

For example, presence-sensitive display 220 may be a built-in component of computing device 200 located within and physically connected to the external packaging of computing device 200. In another example, presence-sensitive display 220 may be an external component of computing device 200 located outside and physically separated from the packaging of computing device 200. In some examples, presence-sensitive display 220, when located outside of and physically separated from the packaging of computing device 200, may be implemented by two separate components: a presence-sensitive input component 240 for receiving input and a display component 248 for providing output.

One or more processors 242 may implement functionality and/or execute instructions associated with computing device 200. Examples of one or more processors 242 include application processors, display controllers, auxiliary processors, one or more sensor hubs, and any other hardware configured to function as a processor, a processing unit, or a processing device. Operating system 205, applications 206, update module 207, shared libraries 226, sandbox SDKs 228, and the like may be operable (or, in other words, executed) by one or more processors 242 to perform various actions, operations, or functions of computing device 200. That is, operating system 205, applications 206, update module 207, shared libraries 226, sandbox SDKs 228 may form executable bytecode that, when executed, cause one or more processors 242 to perform specific operations in accordance with (e.g., causing computing device 200 to become a specific-purpose computer by which to perform) various aspects of the techniques described herein. For example, one or more processors 242 of computing device 200 may retrieve and execute instructions stored by storage devices 246 that cause one or more processors 242 to perform the operations described herein that are attributed to operating system 205 and applications 206. The instructions, when executed by one or more processors 242, may cause computing device 200 to store information within storage devices 246.

One or more storage devices 246 within computing device 200 may store information for processing during operation of computing device 200 (e.g., computing device 200 may store data accessed by operating system 205 during execution at computing device 200). Storage devices 246 may further store data associated with applications 206, update module 207, shared libraries 226, sandbox SDKs 228.

In some examples, storage device 246 is a temporary memory, meaning that a primary purpose of storage device 246 is not long-term storage. Storage devices 246 on computing device 200 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

In some examples, storage devices 246 may also include one or more computer-readable storage media. Storage devices 246 in some examples include one or more non-transitory computer-readable storage mediums. Storage devices 246 may be configured to store larger amounts of information than typically stored by volatile memory. Storage devices 246 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Storage devices 246 may store program instructions and/or information (e.g., data) associated with operating system 205, applications 206, update module 207, shared libraries 226, and sandbox SDKs 228.

In accordance with techniques of this disclosure, one or more processors 242 may execute update module 207 to update a shared library to a target version of a shared library and/or to update a sandbox SDK to a target version of a sandbox SDK. One or more processors 242 are configured to execute update module 207 to select, out of the versions of a shared library installed at computing device 200, a baseline version of the shared library that is to be patched to generate the target version of the shared library. For example, shared libraries 226 are different versions of the same shared library, which as different versions of a web view component that provides web browsing capabilities to applications linked to a version of the shared library. For instance, application 206A may link to shared library 226A and application 206N may link to shared library 226P.

When application 206A is updated to a new version of application 206A, the new version of application 206A may no longer link to shared library 22A but may instead link to a new version of the shared library. One or more processors 242 are therefore configured to execute update module 207 to patch a version of the shared library (e.g., one of shared libraries 226) to the new version of the shared library to which the new version of application 206A is linked.

One or more processors 242 are configured to execute update module 207 to determine, for a shared library, the versions of shared library that are installed at computing device 200, and may select a baseline version of shared library to be patched from the versions of shared library installed at computing device 200 in order to install a new version of the shared library. For example, update module 207 may call one or more functions of operating system 205 to determine a list of all of the shared libraries installed at computing device 200 and may filter the list using the name of a shared library to determine all of the versions of a shared library installed at computing device 200. Update module may therefore be able to select the baseline version of shared library to be patched from the list of all of the versions of the same shared library installed at computing device 200

One or more processors 242 are configured to execute update module 207 to select, out of the versions of a shared library installed at computing device 200 (e.g., out of shared libraries 226), a most recent version of the shared library that precedes the target version of the shared library as the baseline version of the shared library that is to be patched to generate the target version of shared library. In some examples, the most recent version of the shared library that precedes the target version of the shared library out of the versions of shared library installed at computing device 200 may be the version of the shared library having the highest version number out of the versions of the shared library installed at computing device 200 that is of a lower version number than the target version of the shared library. In some example, the most recent version of the shared library that precedes the target version of the shared library out of the versions of the shared library installed at computing device 200 may be the most recently released version of the shared library that was released prior to the release of the target version of shared library.

One or more processors 242 are configured to execute update module 207 to, in response to determining the baseline version of shared library to be patched, use one or more COMM components 224 to send, to computing system 110, a request to update a shared library to a target version of shared library. The request may indicate the shared library to be updated, such as by including an indication of the name of shared library, such as a name of the shared library package. The request may also indicates the baseline version of shared library to be patched, such as by including an indication of the version number of the baseline version of shared library that is to be patched to generate the target version of the shared library.

One or more processors 242 are configured to execute update module 207 to, in response to sending the request to update shared library to the target version of shared library, use one or more COMM components 224 to receive, from computing system 110, a patch that is to be applied to the baseline version of shared library to generate the target version of shared library. Update module 207 may call one or more functions of operating system 205 to determine the location of the baseline version of shared library in storage devices 246, such as the directory path of the baseline version of shared library, in order to find the baseline version of shared library and may apply the patch to the baseline version of shared library to generate the target version of shared library at computing device 200.

Computing device 200 may also update a sandbox SDK installed at computing device 200 to a target version of the sandbox SDK. For example, sandbox SDKs 228 may include different versions of the same sandbox SDK installed at computing device 200, and one or more processors 242 are also configured to execute update module 207 to select, out of the versions of the sandbox SDKs installed at computing device 200, a baseline version of the sandbox SDK that is to be patched to generate the target version of sandbox SDK.

One or more processors 242 are configured to execute update module 207 to determine, for a sandbox SDK, the versions of that sandbox SDK that are installed at computing device 200, and may select a baseline version of the sandbox SDK to be patched from the versions of sandbox SDK installed at computing device 200 in order to install a new version of the sandbox SDK. For example, update module 207 may call one or more functions of operating system 205 to determine a list of all of the sandbox SDKs installed at computing device 200 and may filter the list using the name of a particular sandbox SDK to determine all of the versions of the particular sandbox SDK installed at computing device 200. Update module 207 may therefore be able to select the baseline version of sandbox SDK to be patched from the list of all of the versions of the same sandbox SDK installed at computing device 200

One or more processors 242 are configured to execute update module 207 to select, out of the versions of a sandbox SDK installed at computing device 200 (e.g., out of sandbox SDKs 228), a most recent version of the sandbox SDK that precedes the target version of the sandbox SDK as the baseline version of the sandbox SDK that is to be patched to generate the target version of the sandbox SDK. In some examples, the most recent version of the sandbox SDK that precedes the target version of the sandbox SDK out of the versions of the sandbox SDK (e.g., sandbox SDKs 228) installed at computing device 200 may be the version of the sandbox SDK having the highest version number out of the versions of the sandbox SDK (e.g., out of sandbox SDKs 228) installed at computing device 200 and that is of a lower version number than the target version of the sandbox SDK. In some example, the most recent version of the sandbox SDK that precedes the target version of the sandbox SDK out of the versions of the sandbox SDK installed at computing device 200 may be the most recently released version of the sandbox SDK that was released prior to the release of the target version of the sandbox SDK.

One or more processors 242 are configured to execute update module 207 to, in response to determining the baseline version of the sandbox SDK to be patched, use one or more COMM components 224 to send, to computing system 110, a request to update a sandbox SDK to a target version of the sandbox SDK. The request may indicate the sandbox SDK to be updated, such as by including an indication of the name of the sandbox SDK, such as a name of the sandbox SDK package. The request may also indicates the baseline version of the sandbox SDK to be patched, such as by including an indication of the version number of the baseline version of the sandbox SDK that is to be patched to generate the target version of the sandbox SDK.

One or more processors 242 are configured to execute update module 207 to, in response to sending the request to update the sandbox SDK to the target version of the sandbox SDK, use one or more COMM components 224 to receive, from computing system 110, a patch that is to be applied to the baseline version of the sandbox SDK to generate the target version of the sandbox SDK. Update module 207 may call one or more functions of operating system 205 to determine the location of the baseline version of the sandbox SDK in storage devices 246, such as the directory path of the baseline version of the sandbox SDK, in order to find the baseline version of the sandbox SDK, and may apply the patch to the baseline version of the sandbox SDK to generate the target version of the sandbox SDK at computing device 200.

In some examples, computing device 200 may patch a sandbox SDK to perform a same-version update of the sandbox SDK. Because sandbox SDKs may execute in sandboxed environments associated with individual applications (e.g., of applications 206) that use the functionality provided by the sandbox SDKs, computing system 110 may, for a particular version of a sandbox SDK, generate individual sandbox SDK packages for each of the different applications that that may use the sandbox SDK. As such, if two different applications use the same version of the same sandbox SDK, computing system 110 may generate separate sandbox SDK packages for the same version of the same sandbox SDK for the different applications. For example, sandbox SDK 228A and sandbox SDK 228J may be the same version of the same SDK where sandbox SDK 228A may execute in a sandboxed environment associated with application 206A and sandbox SDK 228J may execute in a sandboxed environment associated with application 206N.

If there are issues with how computing system 110 generates a particular sandbox SDK package that executes in a sandboxed environment associated with a particular application, computing system 110 may be able to generate a patch to patch the particular sandbox SDK package to fix those issues with the sandbox SDK package without upgrading the sandbox SDK to a newer version of the sandbox SDK. However, computing system 110 may not be able to identify the particular sandbox SDK package that is to be patched based on just the version number of the sandbox SDK, because computing system 110 may have generated multiple sandbox SDK packages (e.g., sandbox SDK 228A and sandbox SDK 228J) for the same version of the sandbox SDK.

Instead, computing system 110 may be able to identify a particular instance of a sandbox SDK based on a derived identifier of the instance of the sandbox SDK. An instance of a sandbox SDK may have a derived identifier, sometimes referred to as a derived package identifier that is generated based on the name (or the package name) of the application that uses (e.g., calls functions of) the instance of the sandbox SDK, the version code of the application that uses the instance of the sandbox SDK, and a cryptographic hash (e.g., a SHA-256 hash) of the instance of the sandbox SDK file. The derived identifier of an instance of the sandbox SDK may not be based on the version number of the sandbox SDK itself to make it difficult for malicious actors to determine the version number of the SDK based on the sandbox SDK's derived identifier. In the example where sandbox SDK 228A and sandbox SDK 228J are instances of the same version of the same sandbox SDK, where sandbox SDK 228A executes in a sandboxed environment associated with application 206A and sandbox SDK 228J executes in a sandboxed environment associated with application 206N, sandbox SDK 228A and sandbox SDK 228J may have different derived identifiers because sandbox SDK 228A and sandbox SDK 228J are used by different applications.

Computing device 200 may communicate with computing system 110 to determine whether there is an update available for an instance of a sandbox SDK (e.g., one of sandbox SDKs 228) and, if there is an update available for that instance of the sandbox SDK, to apply a patch to update the sandbox SDK. One or more processors 242 of computing device 200 are configured to use one or more COMM components 224 to send, to computing system 110, a request to update an instance of a sandbox SDK. The request to update the instance of the SDK may indicate the derived identifier of the instance of the sandbox SDK. Computing system 110 may determine, based on the derived identifier of the sandbox SDK, whether there is an update for the instance of the sandbox SDK. For example, computing system 110 may store or be able to access a list of derived identifiers having available updates, and computing system 110 may lookup the derived identifier of the instance of the sandbox SDK to determine whether there is an update available for the instance of the sandbox SDK.

If computing system 110 determines that there is an update that is available for the instance of the sandbox SDK, computing system 110 may send, to computing device 200, a patch for updating the instance of the sandbox SDK. One or more processors 242 are configured to use one or more COMM components 224 to in response to sending the request to update the sandbox SDK, receive, from computing system 110, a patch for updating the instance of the sandbox SDK. One or more processors 242 are therefore configured to execute update module 207 to apply the patch to the sandbox SDK to update the sandbox SDK.

In some examples, computing system 110 may publish hotfix patches for sandbox SDKs to fix security issues and/or other critical bugs that are present in certain versions of a sandbox SDK. One or more processors 242 are configured to execute update module 207 to determine, for a sandbox SDK installed at computing device 200, a list of the versions of the sandbox SDK installed at computing device 200 and may use one or more COMM components 224 to send a request for hotfix patches that includes indications of the versions of the sandbox SDK installed at computing device 200. In some examples, the versions of sandbox SDKs may follow a format of MAJOR.MINOR.PATCH.

Computing system 110 may receive the request for hotfix patches may determine, based on the versions of the sandbox SDK indicated in the request, one or more versions of the sandbox SDK for which hotfix patches are available. Computing system 110 may therefore send, to computing device 200, one or more hotfix patches for one or more versions of the SDK that are installed at computing device 200.

One or more processors 242 are configured to use one or more COMM components 224 to receive, from computing system 110, a hotfix patch for each of the one or more versions of the sandbox SDK installed at computing device 200. One or more processors 242 are therefore configured to execute update module 207 to apply a corresponding hotfix patch to each of the one or more versions of the sandbox SDK installed at computing device 200.

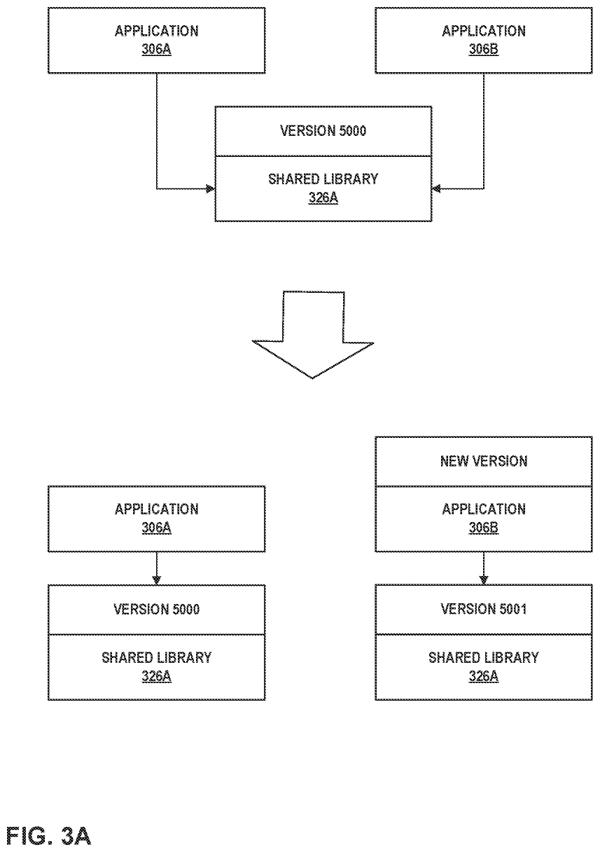

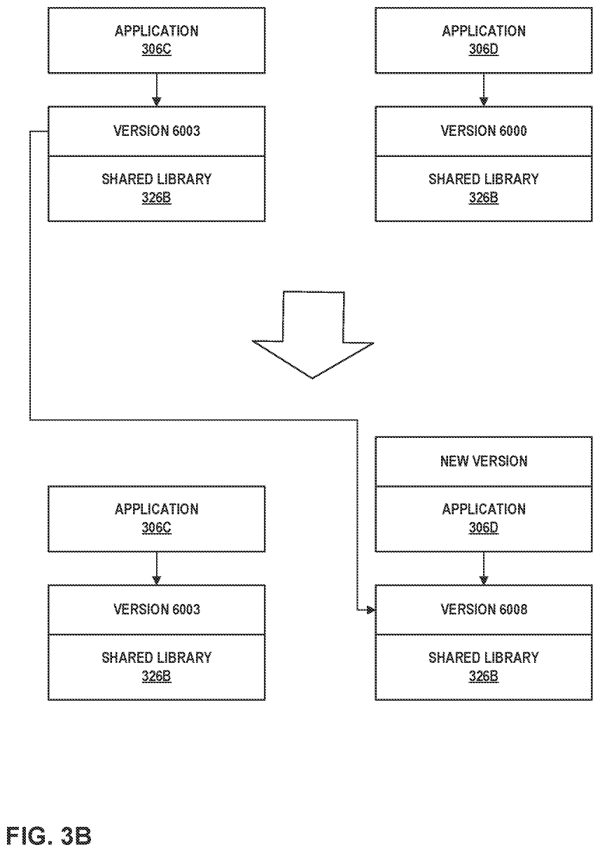

FIGS. 3A and 3B are conceptual diagrams illustrating example techniques for updating shared libraries, in accordance with techniques of this disclosure. FIGS. 3A and 3B are described in the context of computing device 100 and computing system 110 of FIG. 1.

As shown in FIG. 3A, applications 306A and 306B installed at computing device 100 are both linked to version 5000 of shared library 326A installed at computing device 100. Because applications 306A and 306B link to the same version of shared library 326A, applications 306A and 306B may link to the same copy of version 5000 of shared library 326A.

Computing device 100 may update application 306B to a new version of application 306B that links to version 5001 of shared library 326A. Because the only version of shared library 326A installed at computing device 100 is version 5000 of shared library 326A, computing device 100 may determine the baseline version of shared library 326A to be version 5000 of shared library 326A. Further, because the new version of application 306B links to version 5001 of shared library 326A, computing device 100 may determine the target version of shared library 326A to be version 5001 of shared library 326A.

Computing device 100 may therefore send, to computing system 110, an update request that indicates the baseline version of shared library 326A, which in the example of FIG. 3A is version 5000 of shared library 326A, and may, in response, receive, from computing system 110, a patch for patching version 5000 of shared library 326A to version 5001 of shared library 326A. Computing device 100 may therefore apply the patch to version 5000 of shared library 326A to generate version 5001 of shared library 326A.

Because application 306A still depends on version 5000 of shared library 326A, computing device 100 may apply the patch to version 5000 of shared library 326A to generate version 5001 of shared library 326A without overwriting version 5000 of shared library 326A. Instead, computing device 100 may persist version 5000 of shared library 326A. That is, version 5000 of shared library 326A may continue to be installed at computing device 100 even after version 5000 of shared library 326A is patched to generate version 5001 of shared library 326A at computing device 100.

As shown in FIG. 3B, application 306C installed at computing device 100 is linked to version 6003 of shared library 326B installed at computing device 100 and application 306D installed at computing device 100 is linked to version 6000 of shared library 326B installed at computing device 100. Computing device 100 may update application 306D to a new version of application 306D that links to version 6008 of shared library 326B. Computing device 100 may therefore determine a baseline version of shared library 326B out of version 6003 of shared library 326B installed at computing device 100 and version 6000 of shared library 326B installed at computing device 100 that is to be patched to generate version 6008 of shared library 326B.

Computing device 100 may determine that version 6003 of shared library 326B is the most recent version of shared library 326B out of versions 6003 and 6000 of shared library 326B installed at computing device 100 that precedes version 6008 of shared library 326B. As such, computing device 100 may determine the baseline version of shared library 326B to be version 6003 of shared library 326B.

Computing device 100 may therefore send, to computing system 110, an update request that indicates the baseline version of shared library 326B, which in the example of FIG. 3A is version 6003 of shared library 326B, and may, in response, receive, from computing system 110, a patch for patching version 6003 of shared library 326B to version 6008 of shared library 326B. Computing device 100 may therefore apply the patch to version 6003 of shared library 326B to generate version 6008 of shared library 326B.

Note that even though version 6003 of shared library 326B is linked by application 306C but is not linked by application 306D, computing device 100 may nonetheless patch version 6003 of shared library 326B linked by application 306D to generate version 6008 of shared library 326B linked to by the new version of application 306D. Further, because application 306C still depends on version 6003 of shared library 326B, computing device 100 may apply the patch to version 6003 of shared library 326B to generate version 6008 of shared library 326B without overwriting version 6003 of shared library 326B. Instead, computing device 100 may persist version 6003 of shared library 326B. That is, version 6003 of shared library 326B may continue to be installed at computing device 100 even after version 6003 of shared library 326B is patched to generate version 6008 of shared library 326B at computing device 100.

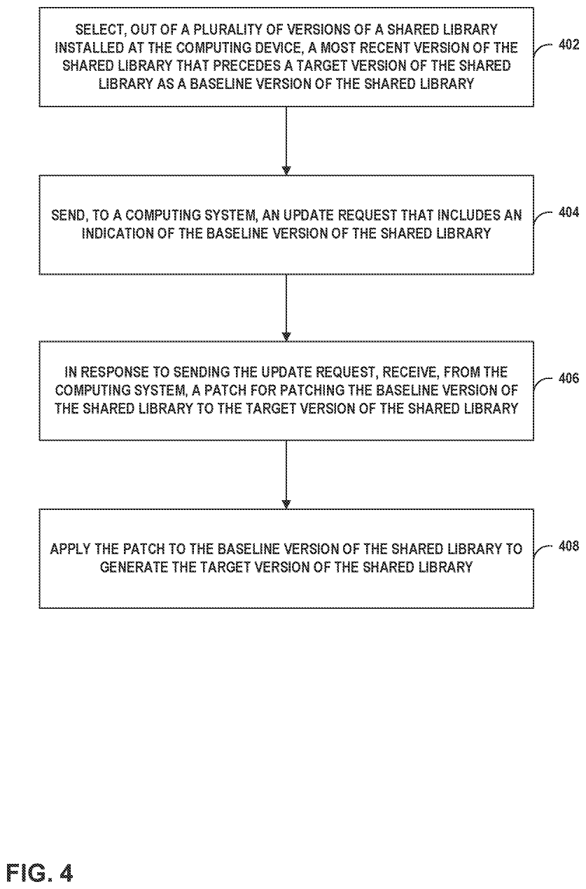

FIG. 4 is a flowchart illustrating another exemplary operation of a computing device in accordance with techniques of this disclosure. FIG. 4 is described in the context of computing system 110 of FIG. 1 and computing device 200 of FIG. 2.

As shown in FIG. 4, one or more processors 242 of computing device 200 may select,
out of a plurality of versions of a shared library installed at the computing device 200, a most recent version of the shared library that precedes a target version of the shared library as a baseline version of the shared library (402). For example, to select the most recent version of the shared library installed at the computing device that precedes the target version of the shared library as the baseline version of the shared library, one or more processors 242 may a highest version of the shared library installed at the computing device having a highest version number out of the plurality of versions of the shared library installed at the computing device that is of a lower version number than the target version of the shared library as the baseline version of the shared library.

Such a shared library may be a static shared library that is not backwards compatible with previous versions of the shared library. As such, an application may use a particular version of a shared library, but may be unable to use a different version of the same shared library.

One or more processors 242 may use one or more COMM components 224 to send, to a computing system 110, an update request that includes an indication of the baseline version of the shared library (404). Computing system 110 may use the indication of the baseline version of the shared library to generate a patch, such as in the form of a delta patch, for updating the baseline version of the shared library to the target version of the shared library and may send the patch to computing device 200.

One or more processors 242 may, in response to sending the update request, receive, from the computing system 110 using one or more COMM components 224, a patch for patching the baseline version of the shared library to the target version of the shared library (406). As described above, the patch may be a delta patch that may include code and data that may be the difference between the code and data of the baseline version of the shared library and the target version of the shared library.

One or more processors 242 may apply the patch to the baseline version of the shared library to generate the target version of the shared library (408).

In some examples, a first application installed at the computing device and a second application installed at the computing device both link to the baseline version of the shared library. When the first application is updated, the updated first application may link to a new version of the shared library, which may be the target version of the shared library.

One or more processors 242 may therefore patch the baseline version of the shared library to generate the target version of the shared library to enable the updated first application to use the target version of the shared library. One or more processors 242 may persist the baseline version of the shared library as the second application still links to the baseline version of the shared library.

In some examples, a first application links to a first version of the shared library installed at the computing device and a second application links to a second version of the shared library installed at the computing device. When the first application is updated, the updated first application may link to a new version of the shared library, which may be the target version of the shared library.

One or more processors 242 may determine that the second version of the shared library linked by the second application is the baseline version of the shared library and may patch the second version of the shared library to generate the target version of the shared library to enable the updated first application to use the target version of the shared library. One or more processors 242 may persist the second version of the shared library as the second application still links to the second version of the shared library.

In some examples, computing device 200 may similarly update versions of a sandbox software development kit (SDK). One or more processors 242 may select, out of a plurality of versions of a sandbox SDK installed at the computing device 200, a most recent version of the sandbox SDK that precedes a target version of the sandbox SDK as a baseline version of the sandbox SDK. One or more processors 242 may send, to a computing system 110, a second update request that includes an indication of the baseline version of the sandbox SDK. One or more processors 242 may, in response to sending the second update request, receive, from the computing system 110, a second patch for patching the baseline version of the sandbox SDK to the target version of the sandbox SDK. One or more processors 242 may apply the second patch to the baseline version of the sandbox SDK to generate the target version of the sandbox SDK.

In some examples, computing device 200 may be able to perform a same-version update of the instance of a sandbox SDK. Such a same-version update may be used to fix an issue with a particular instance of a sandbox SDK installed at computing device 200. One or more processors 242 may determine a derived identifier of an instance of a sandbox SDK that executes in a sandboxed environment associated with an application. One or more processors 242 may send, to the computing system 110, a third update request that includes an indication of the derived identifier of the instance of the sandbox SDK. Such a derived identifier may be different for different instances of the sandbox SDK, including different instances of the same version of the same sandbox SDK. The derived identifier of the instance of the sandbox SDK is based at least in part on an identity of the application associated with the sandboxed environment and a cryptographic hash of the instance of the sandbox SDK.

One or more processors 242 may, in response to sending the third update request, receive, from the computing system 110, a third patch for patching the instance of the sandbox SDK. One or more processors 242 may apply the third patch to the instance of the sandbox SDK to update the instance of the sandbox SDK.

In some examples, one or more processors 242 may further determine a second sandbox SDK that executes in a sandboxed environment associated with a second application. One or more processors 242 may send, to the computing system 110, a hotfix request that includes an indication of a version of the second sandbox SDK. One or more processors 242 may, in response to sending the hotfix request, receive, from the computing system 110, a hotfix patch for patching the second sandbox SDK. One or more processors 242 may apply the hotfix patch to the second sandbox SDK to update the second sandbox SDK.

Aspects of this disclosure include the following examples

Example 1. A method comprising: selecting, by one or more processors of a computing device and out of a plurality of versions of a shared library installed at the computing device, a most recent version of the shared library that precedes a target version of the shared library as a baseline version of the shared library; sending, by the one or more processors to a computing system, an update request that includes an indication of the baseline version of the shared library; in response to sending the update request, receiving, by the one or more processors and from the computing system, a patch for patching the baseline version of the shared library to the target version of the shared library; and applying, by the one or more processors, the patch to the baseline version of the shared library to generate the target version of the shared library.

Example 2. The method of example 1, wherein the shared library is a static shared library that is not backwards compatible with previous versions of the shared library.

Example 3. The method of any of examples 1 and 2, wherein selecting the most recent version of the shared library installed at the computing device that precedes the target version of the shared library as the baseline version of the shared library further comprises: selecting, by the one or more processors, a highest version of the shared library installed at the computing device out of the plurality of versions of the shared library installed at the computing device that is of a lower version than the target version of the shared library as the baseline version of the shared library.

Example 4. The method of any of examples 1-3, wherein a first application installed at the computing device and a second application installed at the computing device are linked to the baseline version of the shared library, and wherein patching the baseline version of the shared library to generate the target version of the shared library further comprises: updating, by the one or more processors, the first application to link the first application to the target version of the shared library; and persisting, by the one or more processors, the baseline version of the shared library at the computing device for use by the second application.

Example 5. The method of any of examples 1-4, wherein a first application links to a first version of the shared library installed at the computing device and a second application links to a second version of the shared library installed at the computing device, wherein the second version of the shared library is selected as the baseline version of the shared library, and wherein patching the baseline version of the shared library to generate the target version of the shared library further comprises: patching, by the one or more processors, the second version of the shared library linked by the second application to generate the target version of the shared library; updating, by the one or more processors, the first application to link the first application to the target version of the shared library; and persisting, by the one or more processors, the second version of the shared library at the computing device for use by the second application.

Example 6. The method of any of examples 1-5, further comprising: selecting, by the one or more processors and out of a plurality of versions of a sandbox software development kit (SDK) installed at the computing device, a most recent version of the sandbox SDK that precedes a target version of the sandbox SDK as a baseline version of the sandbox SDK; sending, by the one or more processors to a computing system, a second update request that includes an indication of the baseline version of the sandbox SDK; in response to sending the second update request, receiving, by the one or more processors and from the computing system, a second patch for patching the baseline version of the sandbox SDK to the target version of the sandbox SDK; and applying, by the one or more processors, the second patch to the baseline version of the sandbox SDK to generate the target version of the sandbox SDK.

Example 7. The method of any of examples 1-6, further comprising: determining, by the one or more processors, a derived identifier of an instance of a sandbox SDK that executes in a sandboxed environment associated with an application; sending, by the one or more processors to the computing system, a third update request that includes an indication of the derived identifier of the instance of the sandbox SDK; in response to sending the third update request, receiving, by the one or more processors and from the computing system, a third patch for patching the instance of the sandbox SDK; and applying, by the one or more processors, the third patch to the instance of the sandbox SDK to update the instance of the sandbox SDK to generate an updated instance of the sandbox SDK.

Example 8. The method of example 7, wherein the derived identifier of the instance of the sandbox SDK is based at least in part on an identity of the application associated with the sandboxed environment and a cryptographic hash of the instance of the sandbox SDK.

Example 9. The method of example 7, wherein applying the third patch to the instance of the sandbox SDK to update the instance of the sandbox SDK comprises: applying, by the one or more processors, the third patch to the instance of the sandbox SDK to perform a same-version update of the instance of the sandbox SDK.

Example 10. The method of any of examples 1-9, further comprising: determining, by the one or more processors, a second sandbox SDK that executes in a sandboxed environment associated with a second application; sending, by the one or more processors to the computing system, a hotfix request that includes an indication of a version of the second sandbox SDK; in response to sending the hotfix request, receiving, by the one or more processors and from the computing system, a hotfix patch for patching the second sandbox SDK; and applying, by the one or more processors, the hotfix patch to the second sandbox SDK to update the second sandbox SDK.

Example 11. A computing device comprising: a memory configured to store a plurality of versions of a shared library installed at the computing device; one or more processors operably coupled to the memory and configured to: select, out of the plurality of versions of a shared library installed at the computing device, a most recent version of the shared library that precedes a target version of the shared library as a baseline version of the shared library; send, to a computing system, an update request that includes an indication of the baseline version of the shared library; in response to sending the update request, receive, from the computing system, a patch for patching the baseline version of the shared library to the target version of the shared library; and apply the patch to the baseline version of the shared library to generate the target version of the shared library.

Example 12. The computing device of example 11, wherein the shared library is a static shared library that is not backwards compatible with previous versions of the shared library.

Example 13. The computing device of any of examples 11 and 12, wherein to select the most recent version of the shared library installed at the computing device that precedes the target version of the shared library as the baseline version of the shared library, the one or more processors are further configured to: select a highest version of the shared library installed at the computing device out of the plurality of versions of the shared library installed at the computing device that is of a lower version than the target version of the shared library as the baseline version of the shared library.

Example 14. The computing device of any of examples 11-13, wherein a first application installed at the computing device and a second application installed at the computing device are linked to the baseline version of the shared library, and wherein to patch the baseline version of the shared library to generate the target version of the shared library, the one or more processors are further configured to: update the first application to link to the target version of the shared library; and persist the baseline version of the shared library at the computing device for use by the second application.

Example 15. The computing device of any of examples 11-14, wherein a first application links to a first version of the shared library installed at the computing device and a second application links to a second version of the shared library installed at the computing device, wherein the second version of the shared library is selected as the baseline version of the shared library, and wherein to patch the baseline version of the shared library to generate the target version of the shared library, the one or more processors are further configured to: patch the second version of the shared library linked by the second application to generate the target version of the shared library; update the first application to link to the target version of the shared library; and persist the second version of the shared library at the computing device for use by the second application.

Example 16. The computing device of any of examples 11-15, wherein the one or more processors are further configured to: select, out of a plurality of versions of a sandbox software development kit (SDK) installed at the computing device, a most recent version of the sandbox SDK that precedes a target version of the sandbox SDK as a baseline version of the sandbox SDK; send, to a computing system, a second update request that includes an indication of the baseline version of the sandbox SDK; in response to sending the second update request, receive, from the computing system, a second patch for patching the baseline version of the sandbox SDK to the target version of the sandbox SDK; and apply the second patch to the baseline version of the sandbox SDK to generate the target version of the sandbox SDK.

Example 17. The computing device of any of examples 11-16, wherein the one or more processors are further configured to: determine a derived identifier of an instance of a sandbox SDK that executes in a sandboxed environment associated with an application; send, to the computing system, a third update request that includes an indication of the derived identifier of the instance of the sandbox SDK; in response to sending the third update request, receive, from the computing system, a third patch for patching the instance of the sandbox SDK; and apply the third patch to the instance of the sandbox SDK to update the instance of the sandbox SDK to generate an updated instance of the SDK.

Example 18. The computing device of example 17, wherein the derived identifier of the instance of the sandbox SDK is based at least in part on an identity of the application associated with the sandboxed environment and a cryptographic hash of the instance of the sandbox SDK.

Example 19. The computing device of example 17, wherein to apply the third patch to the instance of the sandbox SDK to update the instance of the sandbox SDK, the one or more processors are further configured to: apply the third patch to the instance of the sandbox SDK to perform a same-version update of the instance of the sandbox SDK.

Example 20. A computer-readable storage medium encoded with instructions that, when executed by one or more processors of a computing device, cause the one or more processors to: select, out of a plurality of versions of a shared library installed at the computing device, a most recent version of the shared library that precedes a target version of the shared library as a baseline version of the shared library; send, to a computing system, an update request that includes an indication of the baseline version of the shared library; in response to sending the update request, receive, from the computing system, a patch for patching the baseline version of the shared library to the target version of the shared library; and apply the patch to the baseline version of the shared library to generate the target version of the shared library.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
selecting, by one or more processors of a computing device and out of a plurality of versions of a shared library installed at the computing device, a most recent version of the shared library that precedes a target version of the shared library as a baseline version of the shared library;
sending, by the one or more processors to a computing system, an update request that includes an indication of the baseline version of the shared library;
in response to sending the update request, receiving, by the one or more processors and from the computing system, a patch for patching the baseline version of the shared library to the target version of the shared library; and
applying, by the one or more processors, the patch to the baseline version of the shared library to generate the target version of the shared library.

2. The method of claim 1, wherein the shared library is a static shared library that is not backwards compatible with previous versions of the shared library.

3. The method of claim 1, wherein selecting the most recent version of the shared library installed at the computing device that precedes the target version of the shared library as the baseline version of the shared library further comprises:
selecting, by the one or more processors, a highest version of the shared library installed at the computing device out of the plurality of versions of the shared library installed at the computing device that is of a lower version than the target version of the shared library as the baseline version of the shared library.

4. The method of claim 1, wherein a first application installed at the computing device and a second application installed at the computing device are linked to the baseline version of the shared library, and wherein patching the baseline version of the shared library to generate the target version of the shared library further comprises:
updating, by the one or more processors, the first application to link the first application to the target version of the shared library; and
persisting, by the one or more processors, the baseline version of the shared library at the computing device for use by the second application.

5. The method of claim 1, wherein a first application links to a first version of the shared library installed at the computing device and a second application links to a second version of the shared library installed at the computing device, wherein the second version of the shared library is selected as the baseline version of the shared library, and wherein patching the baseline version of the shared library to generate the target version of the shared library further comprises:
patching, by the one or more processors, the second version of the shared library linked by the second application to generate the target version of the shared library;
updating, by the one or more processors, the first application to link the first application to the target version of the shared library; and
persisting, by the one or more processors, the second version of the shared library at the computing device for use by the second application.

6. The method of claim 1, further comprising:
selecting, by the one or more processors and out of a plurality of versions of a sandbox software development kit (SDK) installed at the computing device, a most recent version of the sandbox SDK that precedes a target version of the sandbox SDK as a baseline version of the sandbox SDK;
sending, by the one or more processors to a computing system, a second update request that includes an indication of the baseline version of the sandbox SDK;
in response to sending the second update request, receiving, by the one or more processors and from the computing system, a second patch for patching the baseline version of the sandbox SDK to the target version of the sandbox SDK; and
applying, by the one or more processors, the second patch to the baseline version of the sandbox SDK to generate the target version of the sandbox SDK.

7. The method of claim 1, further comprising:
determining, by the one or more processors, a derived identifier of an instance of a sandbox SDK that executes in a sandboxed environment associated with an application;
sending, by the one or more processors to the computing system, a third update request that includes an indication of the derived identifier of the instance of the sandbox SDK;
in response to sending the third update request, receiving, by the one or more processors and from the computing system, a third patch for patching the instance of the sandbox SDK; and
applying, by the one or more processors, the third patch to the instance of the sandbox SDK to update the instance of the sandbox SDK to generate an updated instance of the sandbox SDK.

8. The method of claim 7, wherein the derived identifier of the instance of the sandbox SDK is based at least in part on an identity of the application associated with the sandboxed environment and a cryptographic hash of the instance of the sandbox SDK.

9. The method of claim 7, wherein applying the third patch to the instance of the sandbox SDK to update the instance of the sandbox SDK comprises:
applying, by the one or more processors, the third patch to the instance of the sandbox SDK to perform a same-version update of the instance of the sandbox SDK.

10. The method of claim 1, further comprising:
determining, by the one or more processors, a second sandbox SDK that executes in a sandboxed environment associated with a second application;
sending, by the one or more processors to the computing system, a hotfix request that includes an indication of a version of the second sandbox SDK;
in response to sending the hotfix request, receiving, by the one or more processors and from the computing system, a hotfix patch for patching the second sandbox SDK; and
applying, by the one or more processors, the hotfix patch to the second sandbox SDK to update the second sandbox SDK.

11. A computing device comprising:
a memory configured to store a plurality of versions of a shared library installed at the computing device;
one or more processors operably coupled to the memory and configured to:
select, out of the plurality of versions of a shared library installed at the computing device, a most recent version of the shared library that precedes a target version of the shared library as a baseline version of the shared library;
send, to a computing system, an update request that includes an indication of the baseline version of the shared library;
in response to sending the update request, receive, from the computing system, a patch for patching the baseline version of the shared library to the target version of the shared library; and
apply the patch to the baseline version of the shared library to generate the target version of the shared library.

12. The computing device of claim 11, wherein the shared library is a static shared library that is not backwards compatible with previous versions of the shared library.

13. The computing device of claim 11, wherein to select the most recent version of the shared library installed at the computing device that precedes the target version of the shared library as the baseline version of the shared library, the one or more processors are further configured to:
select a highest version of the shared library installed at the computing device out of the plurality of versions of the shared library installed at the computing device that is of a lower version than the target version of the shared library as the baseline version of the shared library.

14. The computing device of claim 11, wherein a first application installed at the computing device and a second application installed at the computing device are linked to the baseline version of the shared library, and wherein to patch the baseline version of the shared library to generate the target version of the shared library, the one or more processors are further configured to:
update the first application to link to the target version of the shared library; and
persist the baseline version of the shared library at the computing device for use by the second application.

15. The computing device of claim 11, wherein a first application links to a first version of the shared library installed at the computing device and a second application links to a second version of the shared library installed at the computing device, wherein the second version of the shared library is selected as the baseline version of the shared library, and wherein to patch the baseline version of the shared library to generate the target version of the shared library, the one or more processors are further configured to:
patch the second version of the shared library linked by the second application to generate the target version of the shared library;
update the first application to link to the target version of the shared library; and
persist the second version of the shared library at the computing device for use by the second application.

16. The computing device of claim 11, wherein the one or more processors are further configured to:
select, out of a plurality of versions of a sandbox software development kit (SDK) installed at the computing device, a most recent version of the sandbox SDK that precedes a target version of the sandbox SDK as a baseline version of the sandbox SDK;
send, to a computing system, a second update request that includes an indication of the baseline version of the sandbox SDK;
in response to sending the second update request, receive, from the computing system, a second patch for patching the baseline version of the sandbox SDK to the target version of the sandbox SDK; and
apply the second patch to the baseline version of the sandbox SDK to generate the target version of the sandbox SDK.

17. The computing device of claim 11, wherein the one or more processors are further configured to:
determine a derived identifier of an instance of a sandbox SDK that executes in a sandboxed environment associated with an application;
send, to the computing system, a third update request that includes an indication of the derived identifier of the instance of the sandbox SDK;
in response to sending the third update request, receive, from the computing system, a third patch for patching the instance of the sandbox SDK; and
apply the third patch to the instance of the sandbox SDK to update the instance of the sandbox SDK to generate an updated instance of the SDK.

18. The computing device of claim 17, wherein the derived identifier of the instance of the sandbox SDK is based at least in part on an identity of the application associated with the sandboxed environment and a cryptographic hash of the instance of the sandbox SDK.

19. The computing device of claim 17, wherein to apply the third patch to the instance of the sandbox SDK to update the instance of the sandbox SDK, the one or more processors are further configured to:
apply the third patch to the instance of the sandbox SDK to perform a same-version update of the instance of the sandbox SDK.

20. A computer-readable storage medium encoded with instructions that, when executed by one or more processors of a computing device, cause the one or more processors to:
select, out of a plurality of versions of a shared library installed at the computing device, a most recent version of the shared library that precedes a target version of the shared library as a baseline version of the shared library;
send, to a computing system, an update request that includes an indication of the baseline version of the shared library;
in response to sending the update request, receive, from the computing system, a patch for patching the baseline version of the shared library to the target version of the shared library; and
apply the patch to the baseline version of the shared library to generate the target version of the shared library.
